(19) United States
(12) Patent Application Publication
(10) Pub. No.: US 2005/0241507 A1
(43) Pub. Date: Nov. 3, 2005

(54) Magnetic stamp, kit and method

(75) Inventor: Emily Waters, Draper, UT (US)

Correspondence Address: THORPE NORTH & WESTERN, LLP., 8180 SOUTH 700 EAST, SUITE 200, P.O. BOX 1219, SANDY, UT, 84070, US

(73) Assignee: Making Memories Wholesale, Inc.

(21) Appl. No.: 10/834,793

(22) Filed: Apr. 28, 2004

(51) Int. Cl. B41K 1/04

(52) U.S. Cl. 101/327; 101/333

(57) ABSTRACT

A magnetic stamp includes a plurality of stamp dies magnetically couplable to a stamp plate. An indicator line is disposed on the stamp plate to align the stamp dies on the stamp plate. The stamp can be disposable within a container with a lid. The stamp dies can be magnetically couplable to the lid for storage.

### BACKGROUND OF THE INVENTION

1. Field of the Invention

The present invention relates generally to scrapbooking and photo album activities. More particularly, the present invention relates to a magnetic stamp, kit and method for use in scrapbooking.

2. Related Art

Preserving memories in scrapbooks and photo albums has become an increasingly popular pastime, in which photos and other memorabilia are combined in creative and expressive presentations. Numerous supplies are provided to allow an individual to customize their photos and memorabilia. For example, such supplies include various papers with printed patterns, borders, cutout shapes, etc. The various papers and patterns can be combined to customize a page in the scrapbook, often giving the page a theme. For example, photos of a football game may be laid out on paper having a football field print, while papers patterned as footballs are positioned around the photos. Such creativity and expressiveness are limited only by imagination.

Stamps transfer ink from an ink pad to paper based on the letters formed in the stamp. For example, such stamps were commonly used to stamp dates or other information, such as “paid”, “received”, etc. Some stamps include dates formed on bands rotatably disposed around wheels so that the date can be changed. Some stamps include self inking mechanisms that apply ink to the stamp surface during use.

### SUMMARY OF THE INVENTION

It has been recognized that it would be advantageous to apply the appearance of stamps to scrapebooking or photo album activities. In addition, it has been recognized that it would be advantageous to apply information to scrapebooks and photo albums with stamps.

The invention provides a magnetic stamp device with a plurality of stamp dies magnetically couplable to a stamp plate. The stamp plate can include means for aligning the stamp dies on the stamp plate.

In accordance with a more detailed aspect of the present invention, means for aligning can include an indicator line that is straight and oriented laterally with respect to the stamp plate. In addition, the means for aligning can include an indentation formed in the stamp plate. Furthermore, the means for aligning can include an indicator line printed on the stamp plate.

In addition, the invention provides a magnetic stamp kit with a container and a lid. A stamp and a stamp pad are disposable within the container. The stamp dies are magnetically couplable to the lid.

In addition, the invention provides a method for stamping indicia onto a sheet of media. Stamp dies corresponding to desired indicia are selected and releasably secured the stamp plate. The stamp dies are aligned on the stamp plate with respect to an indicator line associated with the stamp plate. Ink is applied to the stamp dies. The stamp dies are applied to the sheet of media so that the ink from the stamp dies transfers to the sheet of media.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a front elevational view of a magnetic stamp in accordance with an embodiment of the present invention;

FIG. 2 is a bottom view of the magnetic stamp of FIG. 1 shown with representative stamp dies thereon;

FIG. 3 is a partial cross-sectional side view of the magnetic stamp of FIG. 1;

FIG. 4 is a bottom view of another magnetic stamp in accordance with an embodiment of the present invention shown with representative stamp dies thereon;

FIG. 5 is a bottom view of the magnetic stamp of FIG. 1 shown with representative stamp dies thereon;

FIG. 6 is a top view of a kit with a magnetic stamp in accordance with an embodiment of the present invention shown with the lid removed; and

FIG. 7 is a bottom perspective view of a lid of the kit of FIG. 6 shown with representative stamp dies thereon.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

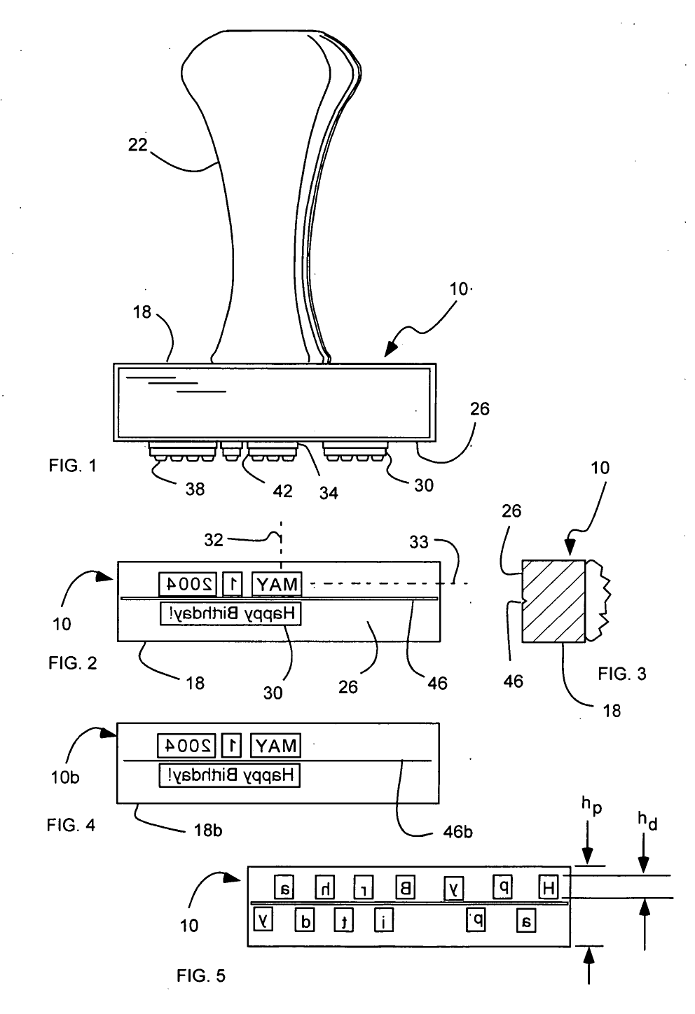

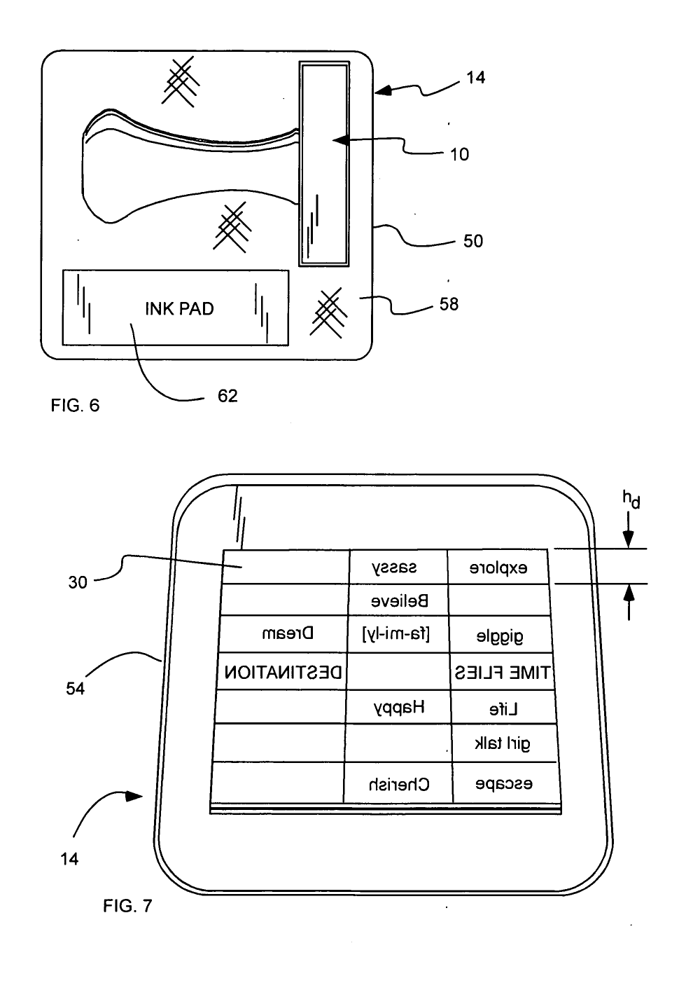

As illustrated in FIGS. 1-3, a stamp or stamp device, indicated generally at 10, in accordance with the present invention is shown for stamping indicia onto a sheet of media, such as paper, card stock, photos, etc. The stamp 10 can form part of a magnetic stamp kit, indicated generally at 14 in FIGS. 4 and 5. Scrapbooking and photo album activities are fields that can benefit from the present invention.

The stamp 10 can be hand held and manually used, and can include a base 18 and a handle 22. The handle 22 can be sized and shaped to facilitate being grasped by a user. The base 18 can be secured or attached to a bottom of the handle 22. The base 18 can include a stamp plate 26 on the bottom thereof to receive stamp dies 30. The stamp dies 30 can be interchangeably and removably disposed on the stamp plate 26 as desired to form a desired indicia. The stamp 10 and stamp dies 30 can have a longitudinal axis 32 and a lateral axis 33. The longitudinal axis can be with respect to an upright orientation of letters or numbers of the stamp dies, described below. In addition, the longitudinal axis 32 can correspond to columns on the stamp plate while the lateral axis 33 can correspond to rows on the stamp plate. It is of course understood that the stamp can be oriented with respect to a sheet of media as desired, and that the stamp dies can be oriented on the stamp plate as desired.

The stamp dies 30 can be magnetically coupled to the stamp 10 or the stamp plate 26. The stamp plate 26 can be metallic, or can be include a ferrous metal. The stamp dies 30 can include a magnetic base 34 that magnetically couples to the stamp plate. Alternatively, the stamp plate can include a magnet, and the stamp dies can include a metal plate with a ferrous metal.

The stamp dies 30 can include a raised portion(s) 38 shaped to form the desired indicia. The raised portion 38 can be formed on, or can protrude from, a sheet of material 42 secured to the magnetic base 34. The sheet of material 42, and thus the raised portions 38, can be flexible and resilient, such as a rubber or the like.

The desired indicia can include, for example, numbers, letters, words, phrases, pictures, figures, designs, art, etc. The numbers and letters can be combined as desired to form words or phrases. For example, the words or phrases can include common terms, such as “Happy Birthday”, etc. The letters, words and phrases can be formed in various different fonts and sizes. For example, the words can be presented in definition or pronunciation format, such as is found in a dictionary. The stamp dies can be arranged as desired to form the indicia in a desired manner.

The stamp plate 26 can be sized to receive the stamp dies 30 in two or more rows or lines. The stamp dies 30 have a longitudinal height h_{d} (with respect to an upright orientation of the letters or numbers). The stamp plate 26 can have a longitudinal height hₚ greater than at least two of the stamp dies, or greater than at least two stamp dies (hₚ≧2h_{d}). Thus, the stamp dies 30 can be arranged in two or more rows.

The stamp plate 26 can advantageously include an alignment line to align the stamp dies 30 on the stamp plate 26, such as in linear rows. The alignment line can be linear or straight, and can be oriented laterally, or from side-to-side. The alignment line can be an elongated indentation 46 formed in the stamp plate 26. Alternatively, the alignment line can be a printed line 46b printed on the stamp plate 26, as shown in FIG. 4. The alignment line can be used to align the stamp dies 30 in linear rows, as is common. Alternatively, the stamp dies 30 can be arranged in other patterns, as shown in FIG. 5. The alignment line, indentation, and printed line are examples of alignment means for aligning the stamp dies on the stamp plate. Other means for aligning can include an elongated protrusion extending from the stamp plate, a printed grid, an indented grid, etc. The stamp dies 30 can be aligned with the alignment line by orienting the stamp die so that it bottom or top edge is parallel with, or collinear with, the alignment line. The alignment line can be positioned between two rows, or positioned in the center of the stamp plate. A first row of stamp dies 30 can be aligned with the alignment line by orienting the stamp dies on the first row with their bottom edges parallel or collinear with the alignment line. Similarly, a second row of stamp dies can be aligned with the alignment line by orienting the stamp dies on the second row with their top edges parallel or collinear with the alignment line. Alternatively, the stamp dies can be oriented with their letters or numbers vertically, in which case the side edges can be oriented with respect to the alignment line.

As described above, the stamp 10 can be provided as part of a magnetic stamp kit 14. The kit 14 can include a container 50 with a lid 54. The stamp 10 can be disposable within the container 50 when not in use. The container 50 can include a cushioning material 58, such as a foam material, with cavities therein to receive the stamp. In addition, the kit 14 can include a stamp pad 62 containing ink, and that is disposable within the container when not in use. Thus, the container can store the stamp and the pad. The container 50 or lid 54 can be formed of tin, or can include a ferrous metal. The stamp dies 30 can be magnetically coupled on an inner surface of the container, such as on an inner or lower surface of the lid. Thus, the stamp dies 30 can be stored in or under the lid. Such storage can resist the stamp dies from contacting one another or other items, and thus can resist ink from inadvertently contacting other items and making a mess.

A method for using the stamp and kit described above, and for stamping indicia onto a sheet of media, includes selecting stamp dies 30 corresponding to desired indicia. The stamp dies are releasably or magnetically secured to the stamp plate 26. The stamp dies can be aligned on the stamp plate with respect to the indicator line, such as the indentation 46 or printed line 46b. Ink from the ink pad can be applied to the stamp dies so that ink is transferred thereto. The stamp dies can then contact the sheet of media so that the ink from the stamp dies transfers to the sheet of media. The stamp dies 30 can be magnetically coupled to the interior surface of the lid 54 of the container 50.

A method for providing the magnetic stamp kit 14 includes providing the container 50 with the lid 54 disposable over an opening in the container to form an enclosure. The stamp 10 is disposed in the container 50. The stamp pad 62 with ink therein is disposed in the container 50. The stamp dies 30 are magnetically coupled to the interior surface of the container.

The kit can include other tools or items, including for example, tweezers to facilitate positioning the stamp dies on the stamp plate.

The stamp can have other configurations, including self-inking configurations, etc.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

1. A magnetic stamp device, comprising:
a) a stamp plate;
b) a plurality of stamp dies, magnetically couplable to the stamp plate; and
c) alignment means, disposed on the stamp plate, for aligning the stamp dies on the stamp plate.

2. A device in accordance with claim 1, wherein each of the stamp dies has a longitudinal height; and wherein the stamp plate has a longitudinal height at least twice as long as the longitudinal height of the stamp dies.

3. A device in accordance with claim 1, wherein the alignment means includes an indicator line that is straight and oriented laterally with respect to the stamp plate.

4. A device in accordance with claim 1, wherein the alignment means includes an elongated indentation formed in the stamp plate.

5. A device in accordance with claim 1, wherein the alignment means includes an indicator line printed on the stamp plate.

6. A device in accordance with claim 1, further comprising:
a handle, coupled to the stamp plate; and wherein each of the plurality of stamp dies includes:
a magnetic base, magnetically coupled to the stamp plate; and
a raised portion shaped and sized to correspond to a desired design.

7. A device in accordance with claim 1, wherein the stamp plate includes a magnet; and wherein each of the plurality of stamp dies includes a ferrous metal base magnetically coupled to the stamp plate by the magnet.

8. A device in accordance with claim 1, further comprising:
a container with a lid, the stamp being disposable within the container; and
the plurality of stamp dies being magnetically couplable to the lid.

9. A magnetic stamp kit, comprising:
a) a container with a lid;
b) a stamp including a stamp plate, disposable within the container;
c) a stamp pad containing ink, disposable within the container; and
d) a plurality of stamp dies magnetically couplable to the lid.

10. A kit in accordance with claim 9, wherein the lid includes a ferrous metal; and wherein each of the plurality of stamp dies includes a magnetic base.

11. A kit in accordance with claim 9, wherein the lid includes a magnet; and wherein each of the plurality of stamp dies includes a base with a ferrous metal.

12. A kit in accordance with claim 9, wherein the stamp plate includes alignment means for aligning the plurality of stamp dies on the stamp plate.

13. A device in accordance with claim 12, wherein the alignment means includes an indicator line that is straight and oriented laterally with respect to the stamp plate.

14. A device in accordance with claim 12, wherein the alignment means includes an elongated indentation formed in the stamp plate.

15. A device in accordance with claim 12, wherein the alignment means includes an indicator line printed on the stamp plate.

16. A device in accordance with claim 12, wherein each of the stamp dies has a longitudinal height; and wherein the stamp plate has a longitudinal height at least twice as long as the longitudinal height of the stamp dies.

17. A method for stamping indicia onto a sheet of media, comprising the steps of:
selecting stamp dies corresponding to desired indicia;
releasably securing the stamp dies to a stamp plate;
aligning the stamp dies on the stamp plate with respect to an indicator line associated with the stamp plate;
applying ink to the stamp dies; and
applying the stamp dies to the sheet of media so that the ink on the stamp dies transfers to the sheet of media.

18. A method in accordance with claim 17, wherein the indicator line is straight and oriented laterally with respect to the stamp plate.

19. A method in accordance with claim 17, wherein the indicator line includes an indentation formed in the stamp plate.

20. A method in accordance with claim 17, wherein the indicator line includes a printed line printed on the stamp plate.

21. A method in accordance with claim 17, further comprising the step of:
magnetically coupling the stamp dies to an interior surface of a lid of a container.

22. A method for providing a magnetic stamp kit, comprising the steps of:
providing a container with a lid disposable over an opening in the container to form an enclosure;
disposing a stamp in the container;
disposing a stamp pad with ink therein in the container; and
magnetically coupling a plurality of stamp dies to an interior surface of the container.

23. A method in accordance with claim 22, wherein the step of providing a container includes providing a container including a ferrous metal.

24. A method in accordance with claim 22, wherein the step of magnetically coupling includes magnetically coupling the plurality of stamp dies to an inner surface of the lid.

25. A method in accordance with claim 22, wherein the step of providing a container includes providing a container with a lid including a ferrous metal; and wherein the step of magnetically coupling include magnetically coupling the plurality of stamp dies to an inner surface of the lid.
